(19) United States
(12) Patent Application Publication
(10) Pub. No.: US 2015/0294528 A1
(43) Pub. Date: Oct. 15, 2015

(54) System and Method for Bingo Game with Multiplier

(71) Applicant: Spin Games LLC, Reno, NV (US)

(72) Inventors: Kent Young, Reno, NV (US); Leilani Bailey, Reno, NV (US); Christopher Baker, Reno, NV (US); Michael C Halvorson, Reno, NV (US)

(73) Assignee: Spin Games LLC, Reno, NV (US)

(21) Appl. No.: 14/249,674

(22) Filed: Apr. 10, 2014

(51) Int. Cl. G07F 17/32

(52) U.S. Cl. CPC G07F 17/329; G07F 17/3211

(57) ABSTRACT

A system and method for a bingo game with a multiplier. A first draw selects a group of numbers from a total game pool that are used to complete a matrix on one or more bingo cards. A second draw selects a subset of the group of numbers as winning numbers. If the winning numbers are configured in a predefined winning pattern on one or more of the bingo cards, that card is a winner. Selection among multiple winning patterns is performed and a multiplier may also be applied to a winning pattern. The multiplier may be randomly assigned. The bingo game is offered on an electronic gaming machine such as a video based slot machine, but may also be deployed in other forms such as on a general purpose computing device in stand-alone form or connected to a network such as the internet.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Electronic gaming machines (“EGMs”) offer a variety of games such as bingo games, slot games, video poker games, roulette games, keno games and other types of wagering games that are commonly deployed at a casino or other establishments for use by players. Play on the EGMs typically requires the player to place a wager on the outcome of a primary game. In particular, the bingo game of the present invention permits a player to play multiple bingo cards where a group of numbers is selected from a pool and distributed into positions in the cards across the multiple cards. Each card is formed in a matrix that is typically 5×3 matrix with 15 positions. Once the cards have been completed with the drawn numbers, a second draw occurs to select a subset from the group of numbers. Those numbers are the “winning numbers.” It is then determined whether the winning numbers are aligned in a predefined pattern on any of the four cards. If so, a card is determined to be a winner. A multiplier may also be applied to the cards, and the multiplier may be assigned to a particular card at random.

Bingo is a standard wagering game where a full set of numbers is used on cards distributed to players. In live bingo, each number in the pool of numbers is represented on a ball in a complete set of balls which is placed in an enclosure. The cards are distributed to players and the balls are drawn at random one at time. Once a ball is drawn from the pool, it is called out for players to mark on their cards and that ball is removed from play for the remainder of the game. As the game progresses, if a player is successful in “catching” a subset of the called numbers in a particular pattern on the card, the player is a winner. Patterns include but are not limited to a straight line across the card horizontally, vertically or from one corner to the opposing corner. Other patterns may also be used including four corners. Bingo is well known in the art and a description of the game of bingo may be found on the Wikipedia website at the link: hitp://en.wikipedia.org/wiki/Bingo_%28U.S.%29. The description of the game of bingo from Wikipedia is incorporated herein by reference in its entirety. Electronic bingo games are also known in the art. An example of such a game is disclosed in U.S. Pat. No. 6,398,645 to Yoseloff and entitled “Electronic Video Bingo With Multi-Card Play Ability,” which is incorporated herein by reference in its entirety.

Historically, the variations of game play for bingo have been appealing to players even though there are typically more losing cards than winning cards. As with all wagering games, the game designers and operators of bingo games are always striving to find appealing features and game functionality that will generate player excitement and increase, or at least maintain the interest of the player.

The present invention defines a method of game play and system that provides more excitement, and maintains the interest of the player in the play of bingo games. It does so by distributing a set of randomly selected numbers from the original number pool across multiple cards. Like other bingo games played in a live format or on an EGM, the player places an initial wager to play. The player then watches as a final subset of the drawn numbers is selected, and the player's cards are marked with catches of the final numbers. If the catches line up in one or more predefined patterns on one or more of the player's cards, the player is awarded a prize in accordance with a predefined paytable. The present invention makes the game more fun and exciting by randomly distributing the initial draw of numbers from the total pool and then selecting the final numbers to complete the game. A random multiplier may also be applied to the cards at the start of the game to build player anticipation and excitement as the game ends, at which time the multiplier is applied to the win for the player to see.

### BRIEF DESCRIPTION OF THE DRAWINGS

For a better understanding of the present invention, and to show more clearly how it functions, reference will now be made, by way of example, to the accompanying drawings. The drawings show embodiments of the present invention in which:

FIG. 1A shows electronic gaming machines for playing a game connected to a network controlled by a server;

FIGS. 1B-1F show networked computing devices for playing a game;

FIG. 2A shows electronic gaming machines for playing a game connected to a network controlled by a server and including a networked bonus game display;

FIG. 2B shows a group of electronic gaming machines on a network connected to a server based system;

FIG. 3 shows a flow chart of bingo game play on an electronic gaming machine with a random multiplier; and

FIGS. 4A-H show screenshots of a bingo game.

### DETAILED DESCRIPTION OF THE INVENTION

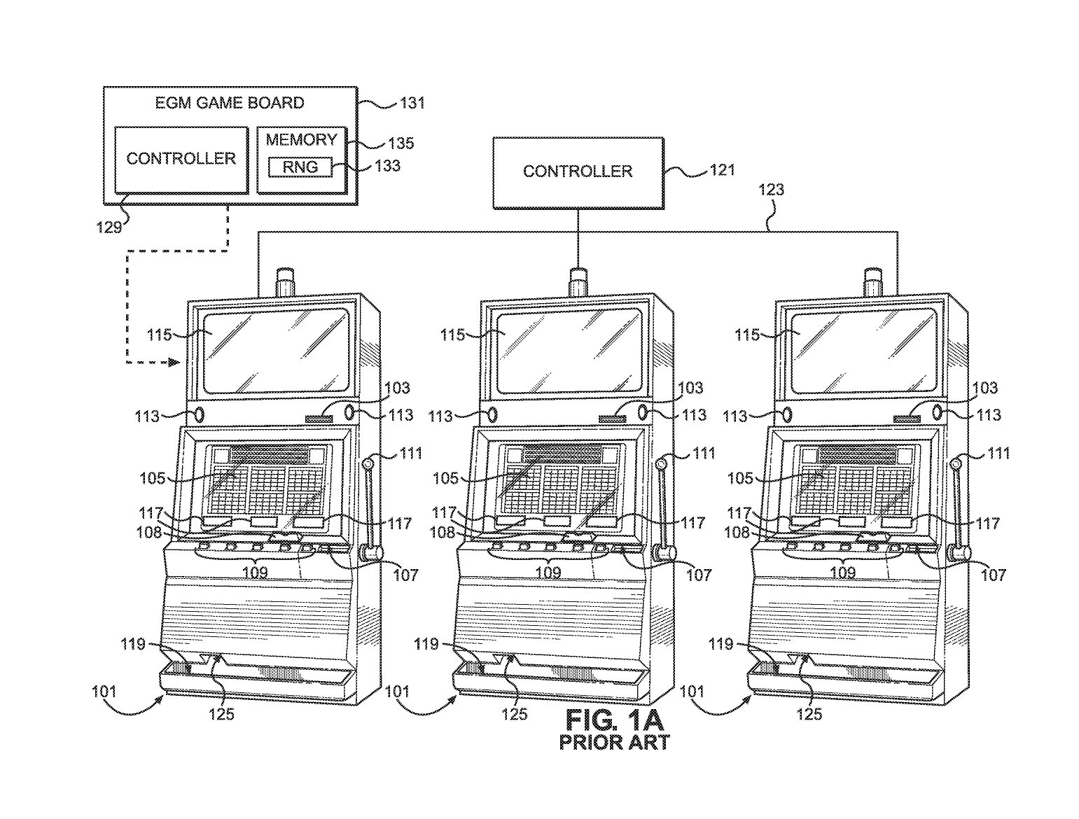

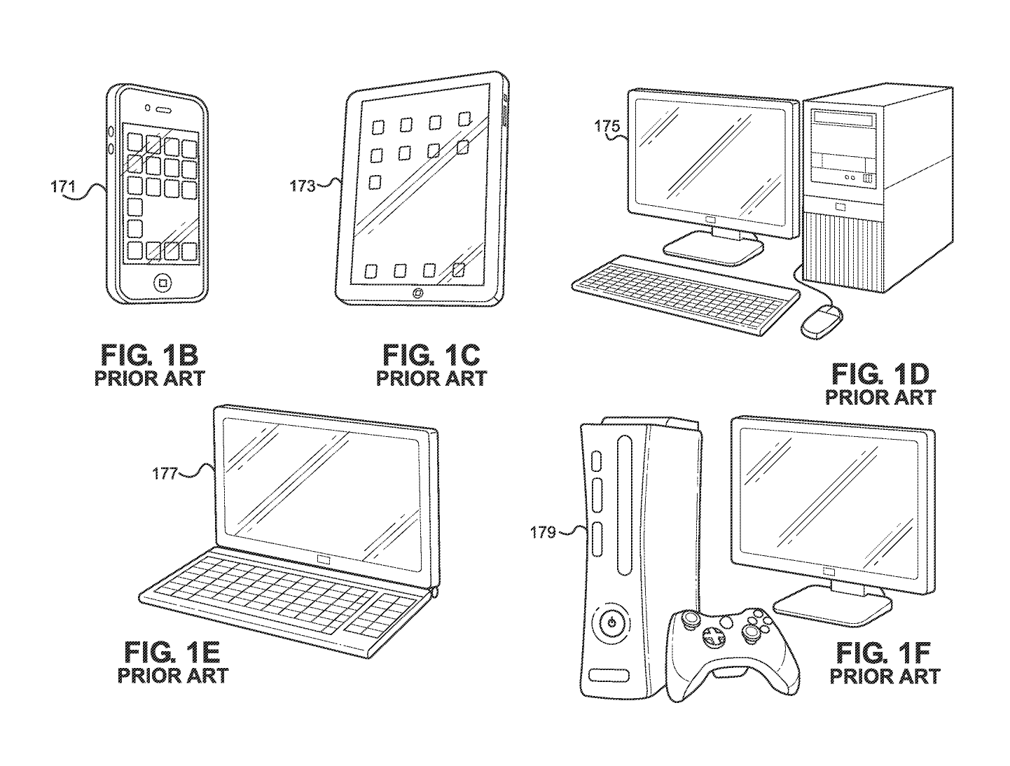

The present invention will now be described more fully with reference to the accompanying drawings. It should be understood that the invention may be embodied in many different forms and should not be construed as limited to the embodiments set forth herein. Throughout FIGS. 1-4, like elements of the invention are referred to by the same reference numerals for consistency purposes.

FIG. 1A shows a group of electronic gaming machines (“EGM”) connected to a central controller. Each EGM 101 is a wagering device that is used in a casino (or other gaming establishment) and may be configured to display and play any of a number of different types of games, including but not limited to bingo, spinning reel type slot games, video reel games, video poker, keno, roulette, craps, blackjack, or any other type of wagering game.

A group of EGMs 101 forms a bank that may be connected together for different types of system applications. For example, a group of EGMs 101 may be linked together for bonusing in a variety of ways, including progressive bonuses where a portion of an amount wagered is applied to a progressive meter that advances as additional games are played. It is also common for EGMs in a casino establishment to be connected to systems for player tracking so that the casino can keep track of the amount of play by each individual player. In that case, each player is issued a player tracking device such as a card that is inserted into a card slot 103 on EGM 101 during play. The card identifies the player to the system and all wagered amounts are tracked for loyalty rewards and other marketing programs of the casino. Other systems connecting EGMs 101 are used for accounting purposes so that a casino operator can monitor and track play, and assess performance of EGMs across the entire casino floor.

Each EGM 101 has a number of components. A display 105 is used to show game play and resulting outcomes. For a bingo game, the display is typically in the form of a video display (shown), but for other types of games such as electromechanical slot games, the video display is replaced with physical reels. Touch screen displays are included on most EGMs and provide a flexible interface for operation of EGM 101, including displaying game cards 106 during play.

Other components include a bill validator and a coin acceptor that are both housed inside EGM 101 into which bills may be inserted through bill slot 107 and coins may be inserted through coin head 108, respectively. Buttons 109 on the exterior of EGM 101 are used to control certain EGM operations in conjunction with touch screen display 105. A handle 111 may be used to initiate play of a game and speakers 113 are used to provide sounds in conjunction with game play and other EGM operations. EGMs further include a top box 115 for displaying pay tables, artwork, advertising or other types of information either on fixed glass or on other displays such as an integrated video panel. Top box 115 may be fitted with a liquid crystal display (“LCD”) screen to permit aspects of game play from either a base game or a secondary game to be shown in top box 115. Meters 117 for tracking credits available for play and other amounts are positioned near the bottom or screen 105. A coin tray 119 at the bottom of EGM 101 is used to catch coins as they are dispensed to a player. It is also common for EGM 101 to include a ticket-in, ticket-out (“TITO”) component that is part of the bill validator housed inside of EGM 101 that may accept bar coded credits through slot 107 and for which the value of the credits is displayed on meters 117 upon a ticket being inserted.

All operational functions of EGM 101 are controlled by a controller 129 such as a microprocessor on a game board 131 housed in side EGM 101. Controller 129 executes one or more programs and uses a random number generator (“RNG”) 133 stored in a memory 135. The operation of the components on EGM game board 131, including controller 129 and memory 133, is well known to those of ordinary skill in the art. Game outcomes are determined based on results corresponding to the numbers generated by RNG 133.

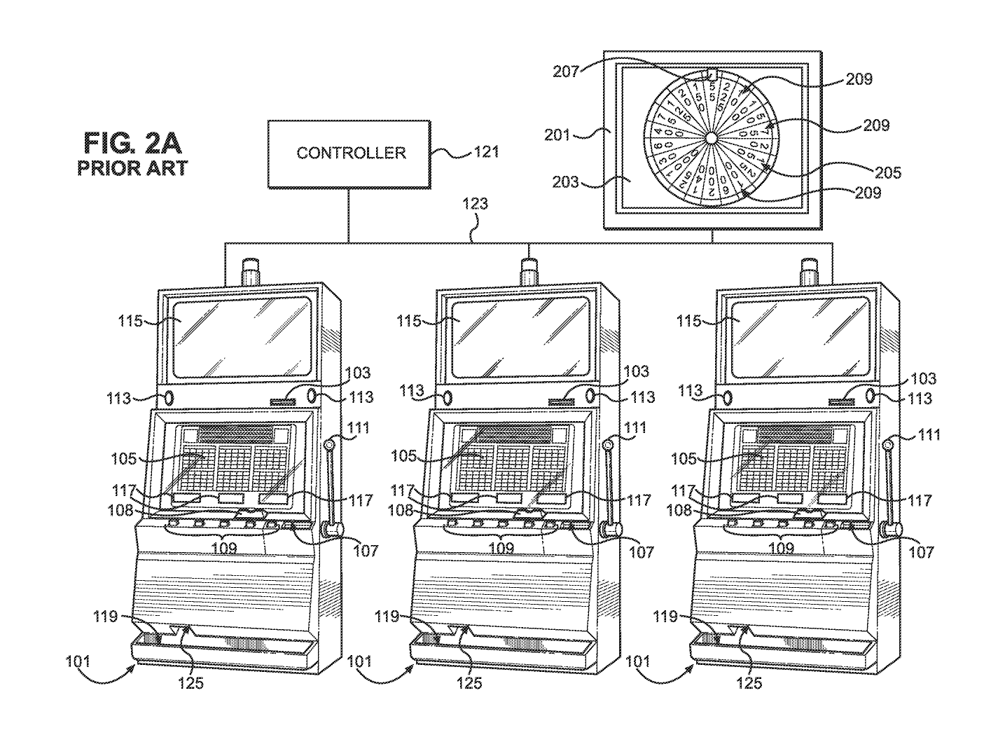

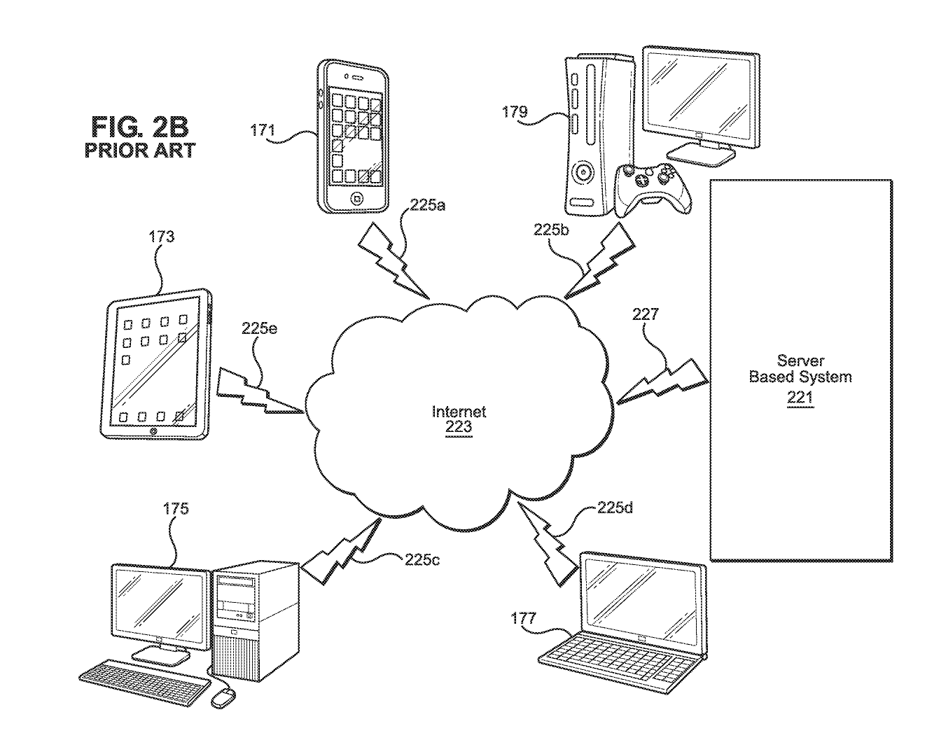

In the system of FIG. 1A, EGMs 101 are connected to an external controller 121 that is used to interface with EGMs 101 to perform a number of different functions, depending on how games on EGMs 101 are configured to operate. For example, controller 121 may instruct EGMs 101 to dispense cash bonuses based on winning events on a networked bonus feature such as a bonus wheel 201 as shown in FIG. 2A. Controller 121 is a microprocessor based device such as a computer or server that is in two-way communication with each of the EGMs 101 in a multi-device system over a network connection 123. Controller 121 receives signals from EGM 101 that may indicate any of a number of different types of events occurring on EGM 101.

FIGS. 1B-1F show a number of general purpose computing devices which may be used to play a game such as a bingo game. These figures show a smartphone 171 in FIG. 1B which may be an Apple iPhone 4S® as pictured, or any other mobile phone type device. A tablet computer 173 is shown in FIG. 1C which may be an Apple iPad 3® as pictured, or any other tablet computing device. A desktop computer 175 is shown in FIG. 1D which may be a Lenovo® machine as pictured, or any other desktop computer. A laptop computer 177 is shown in FIG. 1E which may be a Lenovo® computer or any other laptop computer. And, a home video gaming device 179 is shown in FIG. 1F which may be a Microsoft Xbox® system or any other home video system. Other types of network connected devices could also be used to play games including portable video gaming devices such as a Sony PSP®, a Nintendo GameBoy®, or an internet connected television with a browser or app capabilities. Any of these devices is capable of playing a game, including a wagering game such as bingo, through an app loaded onto the device or through a website accessible using a browser on the device. In the case of the networked game, payment may be made by credit card, Paypal® or another payment service. The RNG is run securely on a server based system and then delivers the outcomes over the internet to be displayed on the general purpose computing device.

FIG. 2A shows a group of EGMs 101 and controller 121 connected on network 123 along with a bonus device 201. Bonus device 201 is shown as a wheel 203 with different potential winning outcome amounts 205 shown on it. Bonus device 201 also includes an indicator 207 to indicate the winning position when wheel 203 comes to a stop. Prize values 209 or other symbols representing different outcomes are shown in the different positions or segments of wheel 203. It should be understood that bonus device 201 may either be in the form of a screen for displaying a bonus indicator such as a wheel or any other indicator representation, or a dedicated bonus feature such as a physical wheel. Bonus device 201 may be incorporated in the housing of EGM 101 such as in top box 115, or it may be a separate device situated nearby to EGM 101 and shared by more than one EGM 101 so that it may be displayed prominently for visitors to a casino establishment to see thereby raising the excitement level for the player playing and the other casino customers. Bonus device 201 may take the form of any bonus indicator, a variety of which are known, including but not limited to reels, “pick a prize” reveal type bonus indicators, timers, arrows, etc. Bonus device 201 may also be in the form of a dedicated device specifically designed for a particular type of bonus, such as a wheel.

In FIG. 2A, EGM 101 is shown as a casino gaming device of the type depicted in FIG. 1A. It should be understood that any one or more of the general purpose computing devices of FIG. 1B-1F—smartphone 171, tablet computer 173, desktop computer 175, laptop computer 177, or home video gaming system 179 shown in FIGS. 1B-1F—could be placed on a network connected to server based system 221 and used to deliver a bingo game as described herein. For purposes of this specification, reference to one or more EGMs 101 in an environment using a limited access intranet of the type typically found in a casino would also apply to one or more general purpose computing devices with a secure connection to a server over the internet and not involving a physical casino property at all, and which may or may not require a wager or payment to play.

FIG. 2B shows server based system 221 connected to a network with multiple computing devices for playing games. It should be understood that the network shown in FIG. 2B operates in a manner similar to the network of FIG. 2A, except that the computing devices on the network of FIG. 2B are connected over the internet 223 with each device 171-179 connected over a secure connection 225a-e to server based system 221 which connects to internet 223 over network connection 227. Payments can be made securely over internet 223 using connections 225a-e, and then delivered to an operator over connection 227. Similarly, the game is executed on server based system 221 using a secure RNG with the outcomes being delivered to the individual devices 171-179 over internet 223. Alternatively, the game software or a portion of it may be resident and executed on each device 171-179. Wagers by players and payments to players may be made using accounts set up with an operator of a website on which the games are run. For purposes of this description, the term electronic gaming machine or EGM 101 refers to any of the individual gaming devices shown in FIG. 1A-1F that is configured to play a bingo game.

It will be understood that the type of network over which data is communicated can be one of several different types of networks. These networks include a Local Area Network (LAN), Wide Area Network (WAN), an intranet or the Internet. Other proprietary networks could also be used without departing from the principles of the invention. This would include such networks as a Windows network or an Ethernet network.

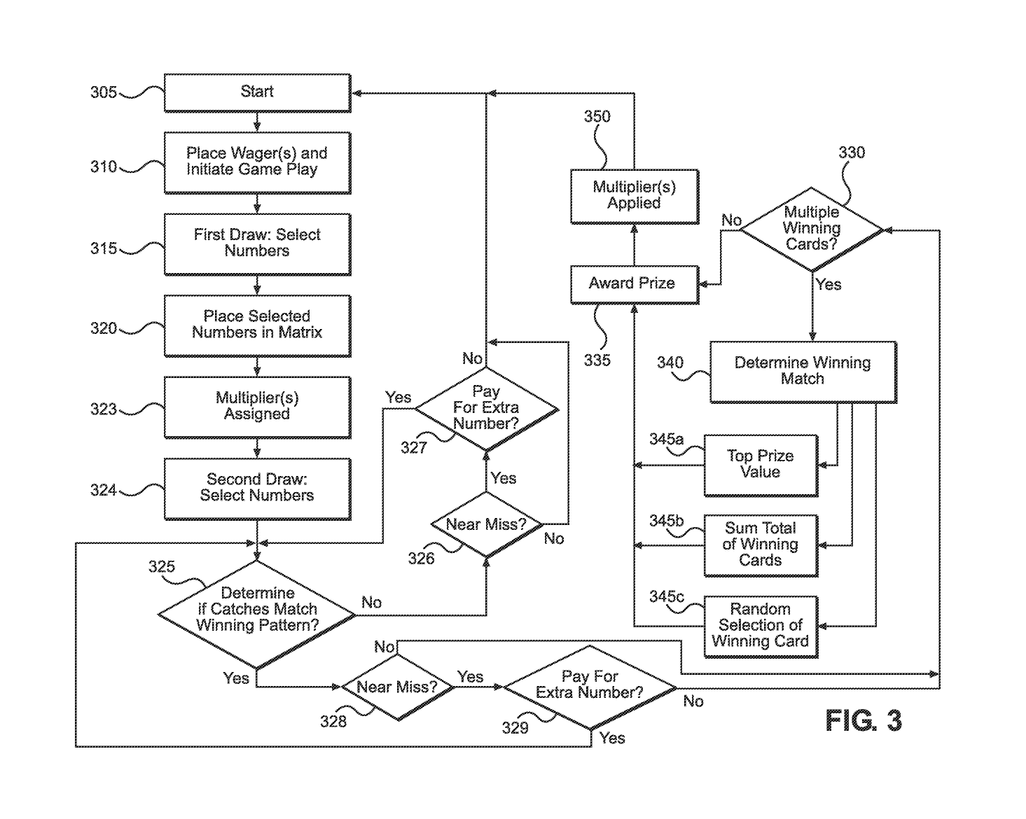

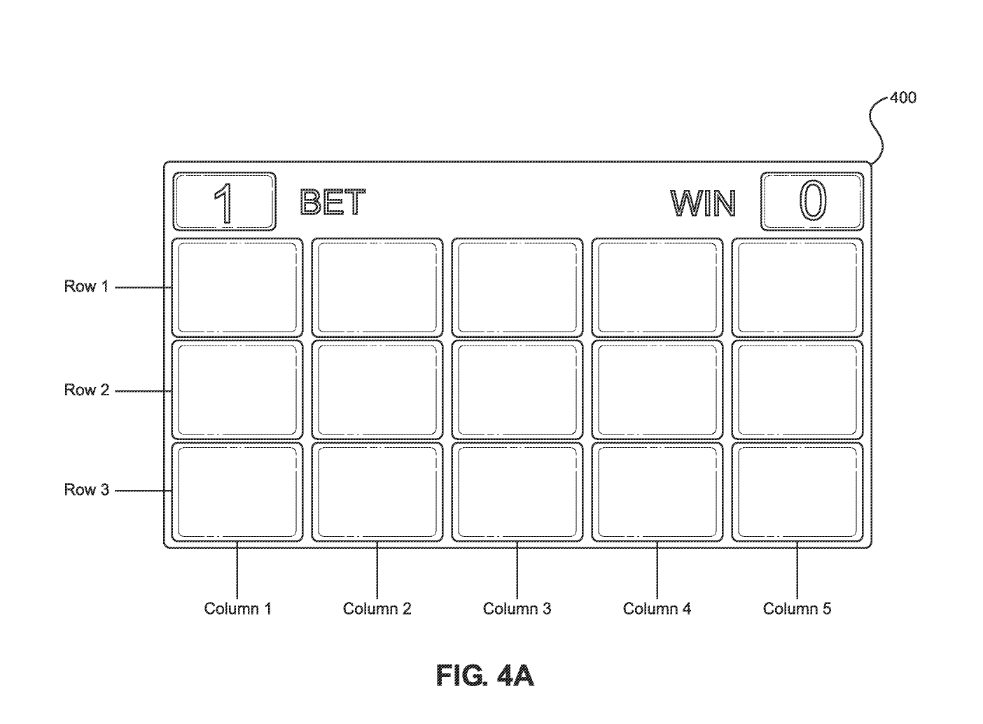

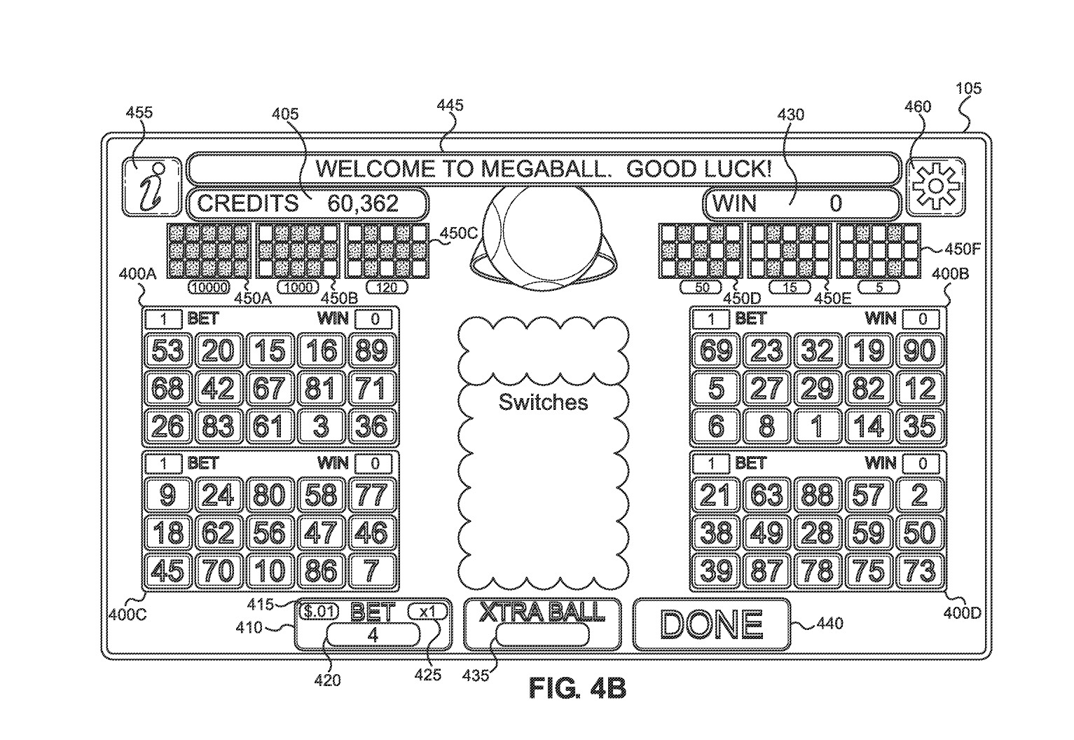

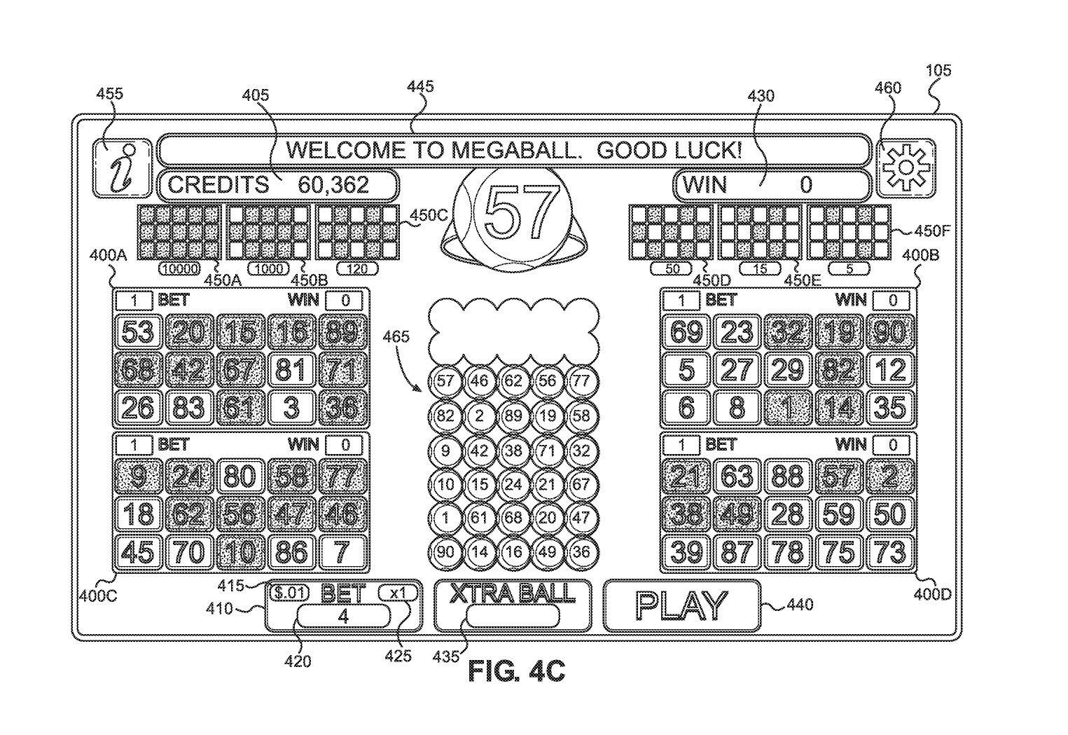

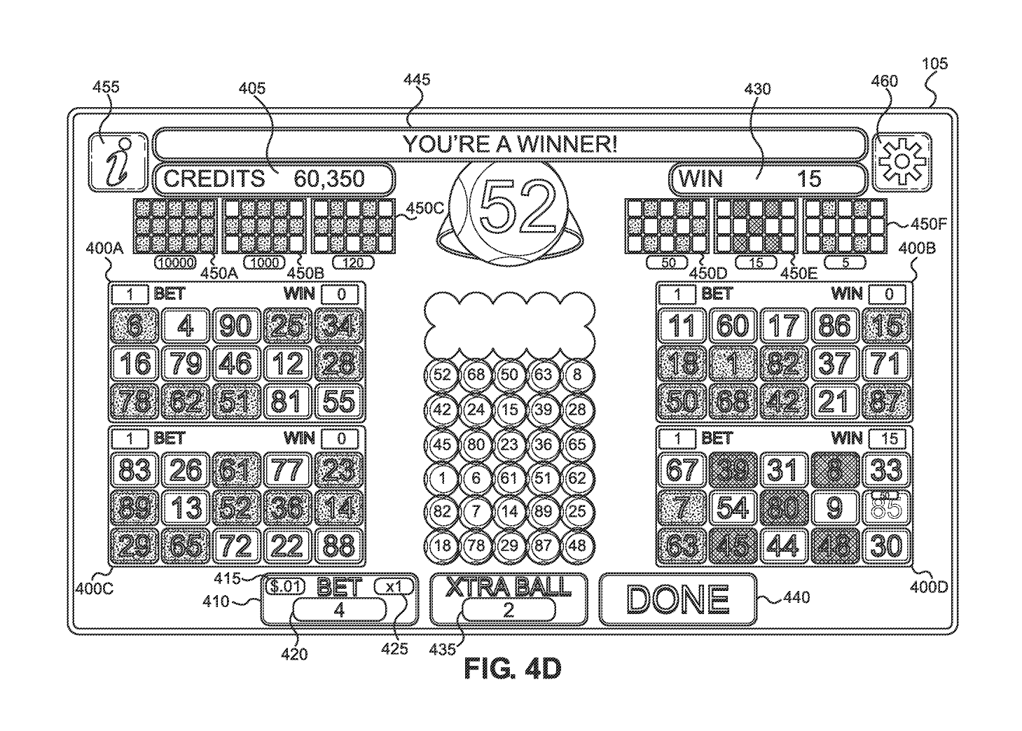

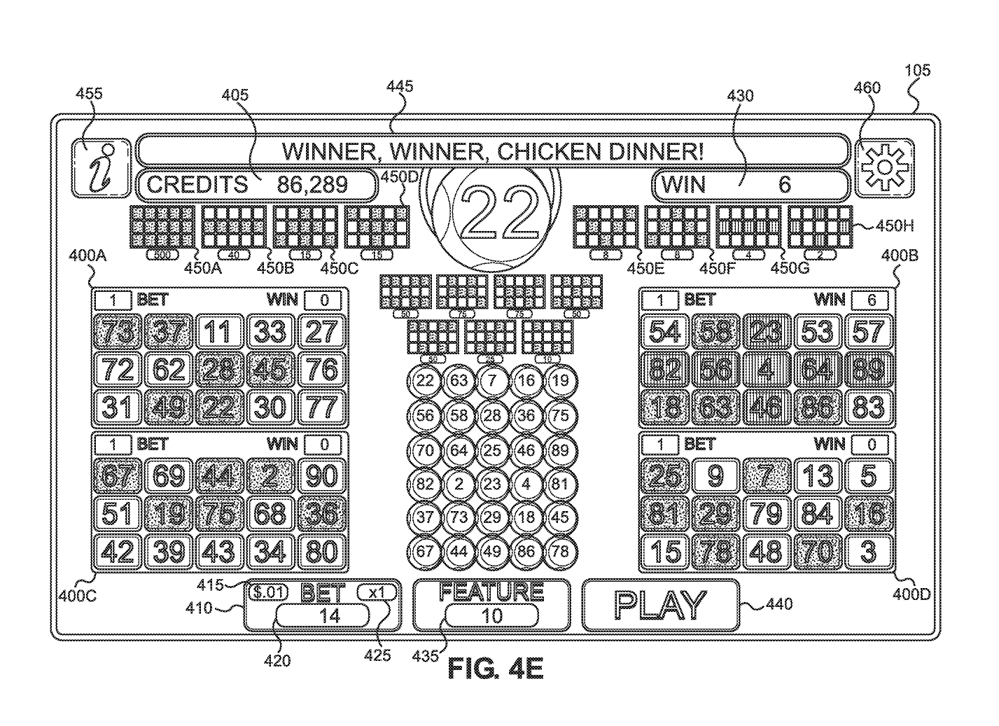

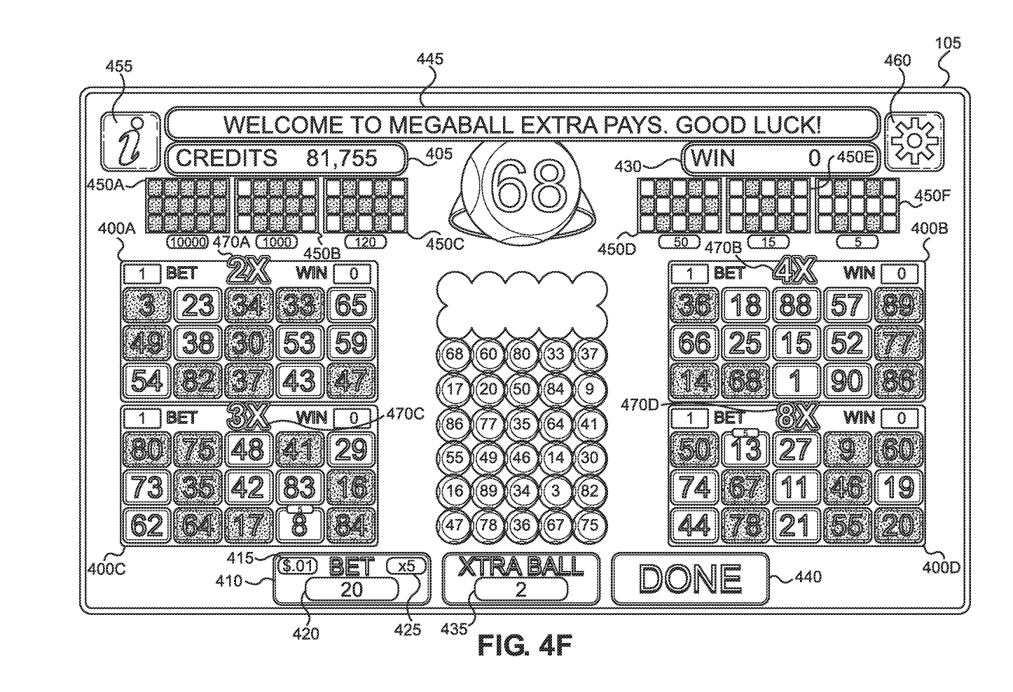

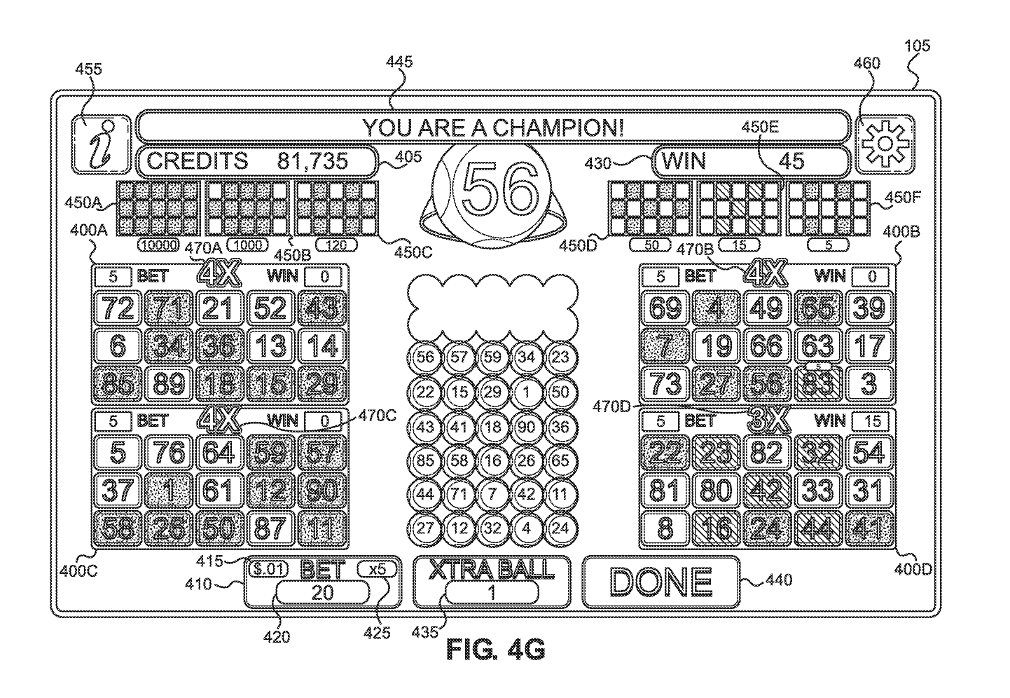

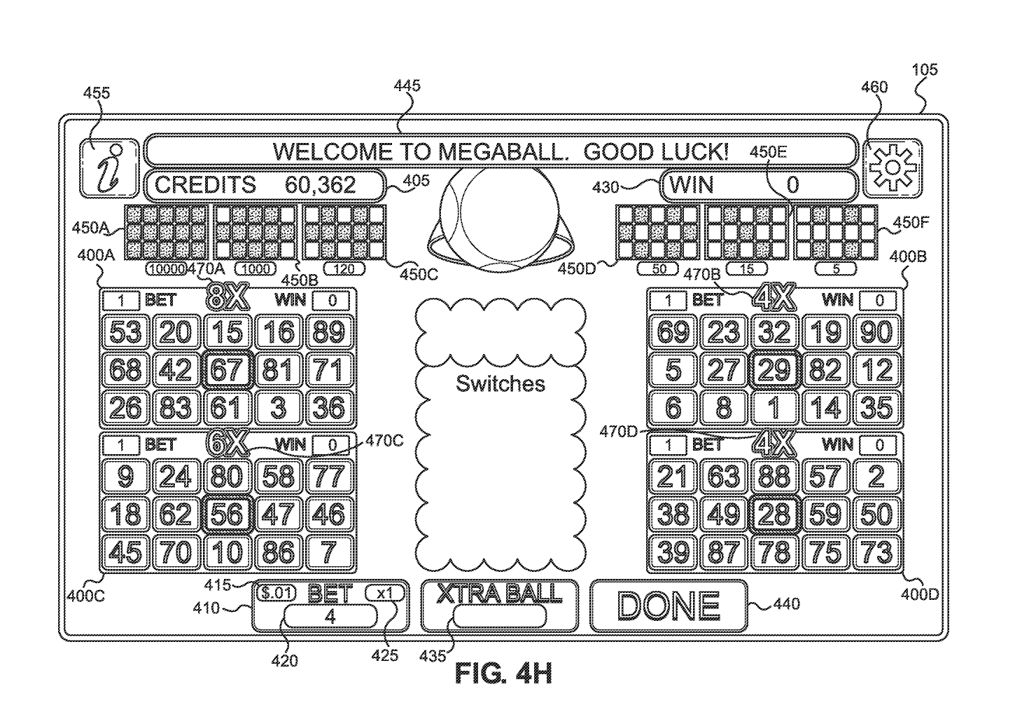

For the EGMs and connected networks shown in FIGS. 1-2, game play on an EGM 101 of the bingo game follows a sequence of steps in the flow chart of FIG. 3 and depicted in the sample screenshots of FIGS. 4A-H. The player begins at start 305 and places a wager 310 to initiate play on EGM 101. The wager may be a single wager that allows the player to play a bingo game. Alternatively, the single wager may allow the player to play a bingo game and also be eligible for a bonus opportunity or a bonus game. Or, the wager may have two components, a first base game wager permitting the player to play the bingo game and a second, optional wager, for the player to be eligible for participation in a bonus opportunity or a bonus game that depends on the outcome of the bingo game. The bonus opportunity may be a multiplier applied to the winning of the base game, and more particularly, the bonus opportunity may be one or more random multipliers assigned to each bingo game card played.

Once the wager or wagers are placed, a first draw is performed at step 315 to select a group of numbers from a complete bingo number pool. For example, the complete bingo number pool may consist of 90 numbers. The draw is intended to provide a subset of the complete bingo pool numbers that are entered into a matrix of positions or spots on bingo cards 400 at step 320. An example of a matrix on bingo card 400 is shown in FIG. 4A. The matrix in the example comprises a 5×3 matrix with 5 vertical columns and 3 horizontal rows. At each position or spot in the matrix, one of the selected numbers is placed at random until all of the positions in the matrices of all cards are filled in. The size of the draw depends on the number of cards to be played, the size of the matrix on the cards and the probabilities of winning outcomes desired by an operator. In sample bingo card 400 of FIG. 4A, there are 15 positions in the matrix, so 15 numbers are needed to be drawn to fill in the positions on each card. Assuming a player plays 4 cards in a single game, the draw would be 60 numbers so that each position is filled with a unique number. It should be understood that a different number of cards could be played in a single game, and that a different sized matrix might be used on the cards. The size of the initial pool of numbers and the size of the subset of numbers selected in the first draw may be adjusted depending on the probabilities of a win required by the game operator.

FIG. 4B is a screenshot of a display 105 showing a sample bingo game with 4 cards 400A-D, each with a 5×3 matrix where a first draw of 60 numbers has been completed and the drawn numbers have been randomly entered in the positions at step 320 on each of four cards 400A-D. Display 105 also includes other information about the sample bingo game such as a credit meter 405 showing the number of credits available for play by the player, a bet box 410 showing the denomination of each bet 415, the total amount bet 420 on the particular play of the game and the amount bet per card 425. A win meter 430 shows the number of credits won at the end of the game. An “Xtra Ball” box 435 is used for offering the player the option, should they choose to exercise it, to draw additional balls to try to win. The player may buy one or more balls, but there is usually a limit on the number of extra balls that may be purchased. In the example game shown and described, the player may buy up to 10 total extra balls, each for a price that varies as the game proceeds and after the initial ball draw is completed. A status box 440 indicates the status of the game to the player and a message box 445 provides notifications and other information to the player before, during and after game play. The player may also get more information about the game such as detailed paytables by touching information box “i” 455, and may change the game settings, such as sound or play-speed, by touching settings box 460.

Bingo game screen 105 also includes a representation of the winning patterns 450 available for the game, along with the corresponding win amount shown just below each of the patterns. In the sample bingo game of FIG. 4B, there are six winning patterns that the player is trying to match. The six winning patterns 450 with win amounts are as follows: (a) full board 450A—10,000; (b) full board except four corners 450B—1,000; (c) full board except four corners and middle top and middle bottom positions 450C—120; (d) checkerboard 450D—50; (e) five spot checkerboard 450E—15; and (f) four spot 450F—5. It should be understood that a winning pattern may include any combination of positions from the matrix on a card. In most games, the number of positions in a pattern required for a win is at least four, but it could be as few as two or three. The fewer the number of spots for a win, the higher the probability of achieving the win and the lower the corresponding payout. For example, any of the following configurations could be winning patterns: (a) a four spot; (b) a five spot; (c) a checkerboard; (d) a four corners; (e) a four spot edge pattern; (f) a “V” pattern; (g) an upside down “V” pattern; (h) a group of positions that touch each other; (i) all positions in the matrix; (j) a straight horizontal line; (k) a straight vertical line; (l) a diagonal line; and (m) a random selection of positions. Other patterns are also shown in the cards of FIGS. 4B-4H.

Once the selected numbers from the first draw at step 315 have been randomly entered into the matrices of each of bingo cards 400A-D and the numbers have been placed in the matrix at step 320, a multiplier may be assigned or selected for each card at step 323. It is also possible to assign the multipliers to the cards at a later time in the process at the discretion of the game designer.

A second draw of selected numbers is performed at step 324. The selected numbers are a subset of the numbers from the first draw and the numbers selected in the second draw are the “winning numbers” among those that were previously placed in the positions in the matrix on bingo game cards 400A-D in the first draw. FIG. 4C is a screenshot of a display 105 showing the sample bingo game with 4 game cards 400A-D where the second draw has taken place at step 324. The numbers selected in the second draw are placed as bingo balls in the center ball area 465 so the player can see them, and they are also highlighted where they appear in each of cards 400A-D.

The bingo cards in play are evaluated to determine whether any of them achieves a pattern of winning numbers at step 325. If none of the cards is a winner, but there is a “near miss,” or the number of “catches” matching one of the winning patterns 450A-F is short of a win by predefined amount at step 326, where the number of catches that the player is short is set by the game designer, the player is given a chance to purchase one or more extra numbers or balls at step 327. If the player decides not to buy an extra ball, the game is a loser and the player is returned to start at step 305. If the player decides to buy an extra ball, the extra ball is provided and the player is returned to step 325 where it is again determined whether the extra ball has resulted in catching a winning pattern. If there was not a near miss at step 326, the game is a loser and the player is returned to start at step 305. It should be understood that near miss step 326 is optional and it is possible to provide the player with an opportunity to purchase extra numbers at step 327 irrespective of the number of catches that the player is short of a win.

In the sample game of FIG. 4C, none of the cards has a winning pattern after step 327. Therefore, if the player wishes to continue play, s/he must return to step 305 and start the game play process over again.

At step 325, if it is determined that one or more of the bingo cards has a pattern of catches or numbers from the second draw matching one of the winning patterns 450A-F, the player is a winner. If a card is a “near miss” for a larger prize at step 328, the player is then given the option at step 329 to purchase an extra number or ball to improve one or more of the cards. If the player decides not to purchase an extra ball, the player moves directly to step 330. If the player decides to purchase an extra ball, the player goes back to step 325 where the cards are re-evaluated after the new ball is provided to determine whether there are additional or better catches. In the event none of the cards are a “near miss” at step 328, the player moves directly to step 330 without being offered the chance to purchase an extra number at step 329. It should be understood that near miss step 328 is optional and it is possible to provide the player with an opportunity to purchase extra numbers at step 329 irrespective of the number of catches that the player is short of a larger win.

In the sample game of FIG. 4D, card 400D is a winner because it matches the 5 spot checkerboard pattern 450E. Therefore, the process continues from step 325 to step 330 (assuming no extra balls are purchased at step 329) where it is determined whether there is more than one winning pattern among the cards 400A-D. Since only card 400D in the sample game of FIG. 4C is a winner, the player is awarded a prize at step 335 and returned to step 305 to start the process over again.

In the event there is more than one winning card among cards 400A-D at step 330, the process continues to step 340 where the winning match to award the player is determined. In one embodiment, the winning match may be determined to be the single top prize among the multiple winning cards at step 345a. In a second embodiment, the player may be awarded the sum of awards for all of the winning cards at step 345b. In yet another embodiment, a random selection of the single winning card from among all of the winning cards may be performed to determine the award paid to the player at step 345c. In any of the different embodiments described for determining the appropriate award to pay, the process continues with the award being paid at step 335. From there, the player is returned to step 305 to begin the process over again.

Another embodiment of the bingo game determines a selection of winning combinations among winning outcomes on a single card. For example, the numbers selected in the final draw provide two winning outcomes on card 400D, a 4-catch matching winning pattern 450F and a 5-catch matching winning pattern 450E. In this case, the player may simply be awarded the highest amount among the winning patterns. Alternatively, the player may be awarded the sum of all winning patterns. Or, the player may be awarded the sum of all patterns except in the case where one pattern trumps another pattern. A “trump” occurs where one pattern “covers” another pattern. In the outcome of FIG. 4D, the 5-catch pattern trumps the 4-catch pattern because all of the numbers in the 4-catch pattern are also in the 5-catch pattern. As a result, only the trumping pattern is awarded between two patterns where one is fully overlapped by the other.

An optional step that may be incorporated into the bingo game play process is the applying of a multiplier to a win at step 350 as previously assigned at step 323. A multiplier is one way to award a player, but it should be understood that other bonus awards to the player may be substituted for a multiplier, such as a free game or awarding one or more free “Xtra Balls” for use by the player. In a first embodiment, once the game has ended, a multiplier of one time, two times, three times, etc. up to a maximum multiplier value set by the game operator, may be randomly selected at step 323 and applied to the final prize awarded to the player at step 350. Alternatively, each of the winning cards in a play of the bingo game may have a randomly selected multiplier applied to it. In that case, the selection of the multiplier would occur at step 323 and the application of the multiplier would occur at step 350 after the determination of a winning match at step 340. The multiplier value would be applied prior to the determination of the prize at any of alternative steps 345a, 345b and 345c.

FIG. 4E is a screenshot of an alternative outcome to a bingo game after completion. As can be seen in FIG. 4E, there are two winning patterns on card 400B: (1) a 5-catch win worth 4 credits with winning positions at all columns of row 2; and (2) a 4-catch win worth 2 credits with winning positions at row 1, column 3; row 2, column 1; row 2, column 5; and row 5, column 3. The wins match winning combination patterns 450E and 450F and the total award to the player is the sum of the two wins, or 6 credits. None of the other cards 400A, 400C and 400D include a winning pattern. In this case, while there is some overlap between the two winning patterns, since there is not a complete overlap of one pattern compared to the other, the lesser paying pattern is not trumped and the player is entitled to receive the sum of all wins.

FIG. 4F is a screenshot of an alternative outcome to a bingo game after completion. As can be seen in FIG. 4F, there are no winning cards. However, this screenshot shows how a multiplier can be assigned to each of the cards. In the game played in FIG. 4F, a multiplier of 2× 470A has been applied to card 400A, a multiplier of 4× 470B has been applied to card 400B, a multiplier of 3× 470C has been applied to card 400C and a multiplier of 8× 470D has been applied to card 400D. If any of these cards had included a winning pattern, the amount won by the player would have been multiplied by the multiplier applied to that card. In this case, the multipliers 470A-D have been randomly assigned/applied to the different cards.

FIG. 4G is a screenshot of an alternative outcome to a bingo game after completion. As can be seen in FIG. 4G, card 400D is a winning card as it has achieved a 5-spot checkerboard pattern matching winning pattern 450E. This screenshot shows multipliers 470A-D applied to each of cards 400A-D at the beginning of play of a game. Multipliers 470A-D were randomly selected from multipliers in a range of 2×-10×. The random selection may be a straight randomization, or alternatively, it may be weighted so that it is more likely to get a lower multiplier than a higher multiplier or vice versa. In the game played in FIG. 4G, a multiplier of 4× 470A has been applied to card 400A, a multiplier of 4× 470B has been applied to card 400B, a multiplier of 4× 470C has been applied to card 400C and a multiplier of 3× 470D has been applied to card 400D. Since card 400D achieves a winning pattern, the amount won by the player is multiplied by the 3× multiplier applied to that card. In this case, 3× multiplier 470D translates to a win of 45, which is equal to a win of 15 credits multiplied by 3. The win of 45 credits is shown on win meter 430.

FIG. 4H is a screenshot of an alternative embodiment for selecting a multiplier for the bingo game. As can be seen in FIG. 4H, on each of cards 400A-D, the center position of the matrix (row 2, column 3) is designated as the multiplier selector. In this embodiment, the multiplier to be applied to the card corresponds to the number randomly selected and filled in the center position of the matrix. For example, each of the numbers from the first draw may be assigned as follows: (a) numbers 1-9 correspond to a multiplier of 2×; (b) numbers 10-29 correspond to a multiplier of 4×; (c) numbers 30-59 correspond to a multiplier of 6×; (d) numbers 60-79 correspond to a multiplier of 8×; and numbers 80-90 correspond to a multiplier of 10×. This screenshot shows multipliers 470A-D applied to each of cards 400A-D. In this case, multipliers 470A-D are applied based on the number randomly selected to appear at the center position in the matrix on each card. In the game played in FIG. 4G, a multiplier of 8× 470A has been applied to card 400A to correspond to number 67 randomly selected for the center position on card 400A, a multiplier of 4× 470B has been applied to card 400B to correspond to number 29 randomly selected for the center position on card 400B, a multiplier of 6× 470C has been applied to card 400C to correspond to number 56 randomly selected for the center position on card 400C and a multiplier of 4× 470D has been applied to card 400D to correspond to number 28 randomly selected for the center position on card 400D.

While the invention has been described with respect to the figures, it will be appreciated that many modifications and changes may be made by those skilled in the art without departing from the spirit of the invention. For example, a particular winning pattern on one of cards 400A-D may trigger a bonus game, such as on wheel display 201 as shown in FIG. 2A. Or, a bonus game may be offered at random to a player participating in play of the bingo game. Any variation and derivation from the above description and drawings are included in the scope of the present invention as defined

What is claimed is:

1. An electronic gaming machine (“EGM”) on which a player plays a game of bingo, comprising:
a random number generator that generates random numbers determining a first draw of numbers from a total pool of numbers that are placed in positions of a matrix on at least one bingo card, and a second draw of numbers that is a subset of the first draw of numbers wherein the second draw of numbers are winning numbers in the matrix on the at least one bingo card;
a display for displaying game play screens including game outcomes to a player; and
a controller for controlling game play on the electronic gaming machine wherein in the event that a predefined pattern is achieved in the matrix on the at least one bingo card among the winning numbers, the card is determined to be a winning card.

2. The EGM of claim 1 wherein a multiplier is applied to each of the at least one bingo cards.

3. The EGM of claim 2 wherein each multiplier is randomly assigned.

4. The EGM of claim 1 wherein each multiplier corresponds to a number selected for a designated position in the matrix on each card.

5. The EGM of claim 1 wherein if there is more than one winning card, the player is awarded based on a win that is among the group comprising: (a) the sum of all wins on all cards; (b) the sum of all wins on a single winning card with the highest award value; (c) the single highest winning value among all winning patterns achieved; (d) the sum of all wins on a single card excepting any win that is trumped by another win on that same card; and (e) a random selection of a win from among all winning patterns achieved.

6. The EGM of claim 1 wherein a first win may be trumped by a second win.

7. The EGM of claim 1 wherein the player is provided with an opportunity to purchase at least one extra number after the second draw.

8. The EGM of claim 1 wherein a near miss is set to a value that is less than a predefined number of catches short of a win and further wherein the purchase of at the at least one extra number after the second draw requires that the player have achieved a near miss.

9. The EGM of claim 1 wherein each number from the first draw of numbers is distributed to a unique position among the positions across the matrices of the at least one bingo card.

10. The EGM of claim 1 wherein the winning pattern is comprised of at least three positions in the matrix on the winning card and is in a configuration from the group comprising: (a) a four spot; (b) a five spot; (c) a checkerboard; (d) a four corners; (e) a four spot edge pattern; (f) a “V” pattern; (g) an upside down “V” pattern; (h) a group of positions that touch each other; (i) all positions in the matrix; (j) a straight horizontal line; (k) a straight vertical line; (l) a diagonal line; and (m) a random selection of positions.

11. The EGM of claim 1 wherein the game of bingo requires a wager to be made by the player.

12. A method of playing a bingo game on an electronic gaming machine (“EGM”), the method comprising the steps of:
generating a first set of random numbers using a random number generator to select a first draw of numbers from a total pool of numbers;
placing the first draw of numbers selected in positions of a matrix on at least one bingo card;
generating a second set of random numbers using the random number generator to select a second draw of numbers that is a subset of the first draw of numbers, wherein the second draw of numbers are winning numbers in the matrix on the at least one bingo card;
displaying game play screens including game outcomes of the bingo game to a player; and
controlling game play on the electronic gaming machine wherein in the event that a predefined pattern is achieved in the matrix on the at least one bingo card among the winning numbers, the card is determined to be a winning card.

13. The method of claim 12 wherein a multiplier is applied to each of the at least one bingo cards.

14. The method of claim 13 wherein each multiplier is randomly assigned.

15. The method of claim 12 wherein each multiplier corresponds to a number selected for a designated position in the matrix on each card.

16. The method of claim 12 wherein if there is more than one winning card, the player is awarded based on a win that is among the group comprising: (a) the sum of all wins on all cards; (b) the sum of all wins on a single winning card with the highest award value; (c) the single highest winning value among all winning patterns achieved; (d) the sum of all wins on a single card excepting any win that is trumped by another win on that same card; and (e) a random selection of a win from among all winning patterns achieved.

17. The method of claim 12 wherein a first win may be trumped by a second win.

18. The method of claim 12 wherein the player is provided with an opportunity to purchase at least one extra number after the second draw.

19. The EGM of claim 18 wherein a near miss is set to a value that is less than a predefined number of catches short of a win and further wherein the purchase of at the at least one extra number after the second draw requires that the player have achieved a near miss.

20. The method of claim 12 wherein each number from the first draw of numbers is distributed to a unique position among the positions across the matrices of the at least one bingo card.

21. The method of claim 12 wherein the winning pattern is comprised of at least three positions in the matrix on the winning card and is in a configuration from the group comprising: (a) a four spot; (b) a five spot; (c) a checkerboard; (d) a four corners; (e) a four spot edge pattern; (f) a “V” pattern; (g) an upside down “V” pattern; (h) a group of positions that touch each other; (i) all positions in the matrix; (j) a straight horizontal line; (k) a straight vertical line; (l) a diagonal line; and (m) a random selection of positions.

22. The method of claim 12 wherein the game of bingo requires a wager to be made by the player.
